(19) United States
(12) Patent Application Publication
(10) Pub. No.: US 2010/0263384 A1
(43) Pub. Date: Oct. 21, 2010

(54) COMBUSTOR CAP WITH SHAPED EFFUSION COOLING HOLES

(76) Inventor: Ronald James CHILA, Greer, SC (US)

Correspondence Address: NIXON & VANDERHYE P.C., 901 NORTH GLEBE ROAD, 11TH FLOOR, ARLINGTON, VA, 22203, US

(21) Appl. No.: 12/425,414

(22) Filed: Apr. 17, 2009

(51) Int. Cl. F02C 7/00

(52) U.S. Cl. 60/755

(57) ABSTRACT

A combustor cap assembly for a gas turbine includes a plurality of effusion cooling apertures that allow air to pass through the cooling apertures to cool the combustor cap assembly. An inner diameter of the cooling apertures expands along at least a portion of the total length of the apertures so that cooling air passing through the cooling aperture will slow as it approaches the outlet.

### BACKGROUND OF THE INVENTION

The invention relates to combustor caps for combustors of gas turbines, and more specifically, to effusion cooling holes formed in combustor caps.

### BRIEF DESCRIPTION OF THE INVENTION

Combustor cap assemblies have evolved over the years from a single fuel nozzle configuration to a multi-nozzle dry low NOx configuration with dual burning zone capability.

The function of the cap primary nozzle cup assembly is to deliver fuel and air from the fuel nozzle and end cover assembly to the primary zone of the combustor. Air and fuel pass axially through each primary nozzle cup. Air passes through the sidewalls of each primary cup in a radially inward direction, providing cooling for the cup wall. Air also passes through multiple apertures in the cap impingement plate, thereby cooling the impingement plate and supplementing the total cap airflow.

### SUMMARY OF THE INVENTION

In one aspect, the invention may be embodied in a combustor cap for a gas turbine that includes an outer sleeve and an impingement plate mounted in the outer sleeve, wherein a plurality of cooling apertures are formed in the impingement plate, and wherein for at least some of the cooling apertures, an area of an inlet of the cooling aperture is smaller than an area of an outlet of the cooling aperture.

In another aspect, the invention may be embodied in a method of forming a combustor cap for a turbine that includes the steps of forming a plurality of cooling apertures in an impingement plate, wherein for at least some of the cooling apertures, an area of an inlet of the cooling aperture is smaller than an area of an outlet of the cooling aperture, and mounting the impingement plate in an outer sleeve.

### BRIEF DESCRIPTION OF THE DRAWINGS

FIG. 1 is a side sectional view of a combustor cap assembly;

FIG. 2 is an enlarged detail of a portion of the sectional view illustrated in FIG. 1;

FIG. 3 is a rear elevation of the combustor cap assembly illustrated in FIG. 1;

FIG. 4 is a partial front elevation of the combustor cap assembly illustrated in FIG. 1;

FIG. 5 is a cross-sectional view showing the profile of a cooling aperture formed in nozzle cup or an impingement plate of a combustor cap assembly;

FIG. 6 is a cross-sectional view showing the profile of an alternate embodiment of a cooling aperture;

FIG. 7 is a cross-sectional view showing the profile of yet another embodiment of a cooling aperture;

FIG. 8 is a cross-sectional view showing a profile of another embodiment of a cooling aperture;

FIG. 9 is a cross-sectional view showing a profile of another embodiment of a cooling aperture;

FIG. 10 is a cross-sectional view showing a profile of another embodiment of a cooling aperture;

FIG. 11 is a cross-sectional view showing a profile of another embodiment of a cooling aperture;

FIG. 12 is a cross-sectional view showing a profile of another embodiment of a cooling aperture;

FIG. 13a is a top view showing a cooling aperture formed in a portion of a combustor cap assembly;

FIG. 13b is a bottom view showing the cooling aperture formed in the combustor cap assembly; and

FIG. 13c is a cross-sectional perspective view showing the profile of the cooling aperture illustrated in FIGS. 13a and 13b.

### DETAILED DESCRIPTION OF PREFERRED EMBODIMENTS

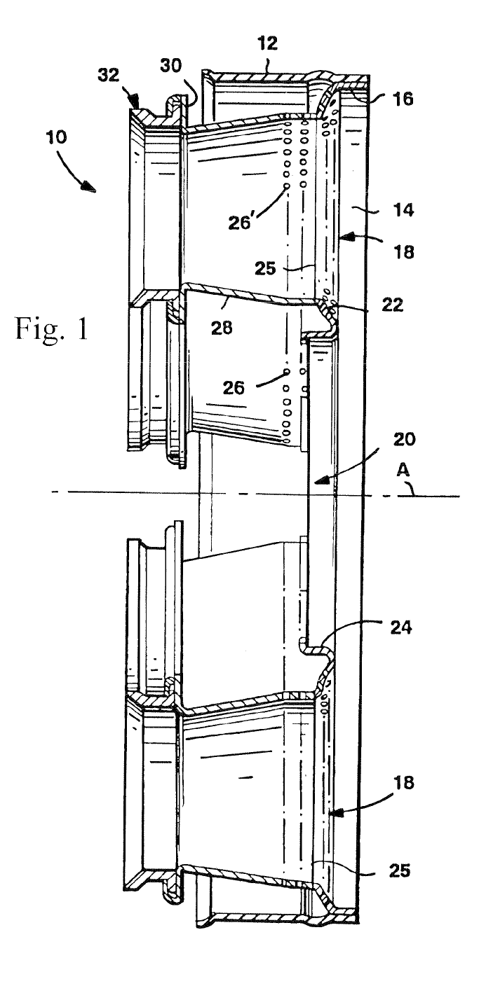

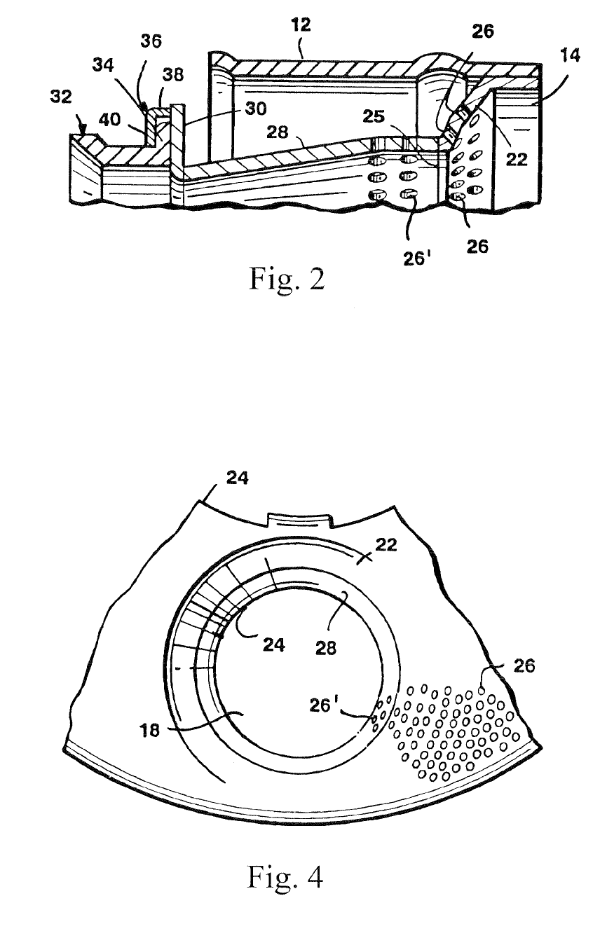

With reference to the drawings, particularly FIGS. 1 and 2, a combustor cap assembly 10 includes a generally cylindrical, open-ended cap sleeve 12, which is adapted for connection by any suitable means, such as bolts, to the combustor casing assembly (not shown).

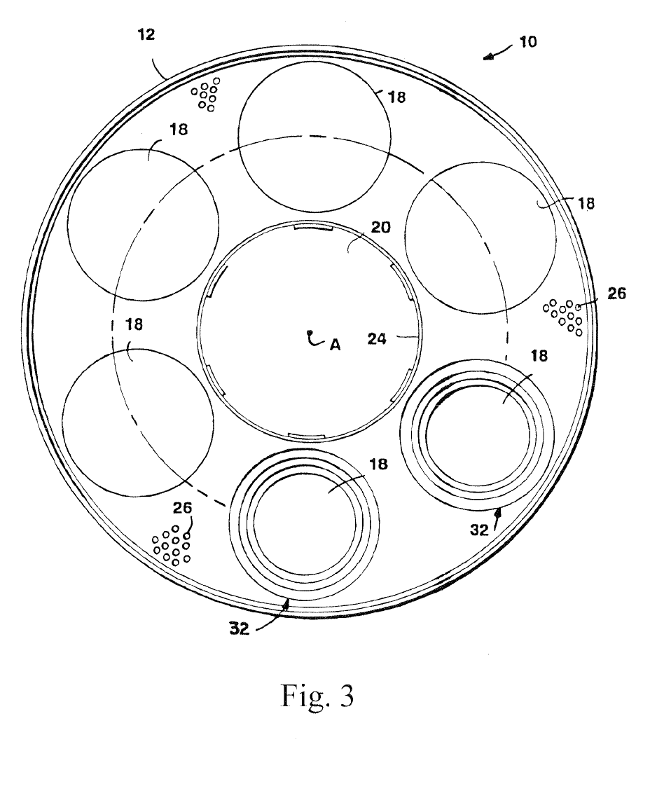

The cap sleeve 12 receives within its forward open end an impingement plate 14 which includes a forwardly extending, outer annular ring portion adapted to frictionally engage, and be welded to, the inner surface of sleeve 12. The impingement plate also includes, in the exemplary embodiment, six primary fuel nozzle openings 18, and a single, centrally located secondary fuel nozzle opening 20, as best seen in FIG. 3. The circular openings 18 are arranged in a circular array about the center axis A and about the circular secondary nozzle opening 20. For each opening or hole 18, there is an inwardly and rearwardly extending inclined or tapered plate portion 22 which defines the openings 18. The impingement plate center hole 20 has an inner annular ring 24 welded thereto, extending rearwardly, or away from the combustion zone.

Although the embodiment illustrated in FIGS. 1-4 includes six primary fuel nozzle openings 18 and one central secondary fuel nozzle opening 20, in alternate embodiments, different numbers and arrangements of the primary and secondary fuel nozzle openings could be provided. Further, in some embodiments, there may be no secondary fuel nozzle opening.

The impingement cooling plate 14, including the tapered portions 22 and all areas between the primary fuel nozzle openings 18 (but excluding the inner and outer annular rings 16 and 24) is formed with an array of cooling apertures 26, extending over substantially the entire surface thereof. Air flowing through the impingement plate 14 serves to cool the plate and to supplement the total cap assembly airflow used in the combustion process.

In preferred embodiments, the cooling apertures 26 are formed over substantially the entire surface of the impingement plate. However, in alternate embodiments, the cooling apertures could be formed on only a selected portion of the impingement plate. For instance, in some embodiments the cooling apertures may only be provided in areas of the impingement plate which experiences high operating temperatures.

Cooling apertures 26′ are also provided in the nozzle cups 28, as shown in FIGS. 1 and 2. These cooling apertures 26′ might have the same configuration as the cooling apertures in the impingement plate, or a different configuration, depending on the design of a particular combustor cap assembly. Also, the cooling apertures 26′ could be formed on all portions of the nozzle cups 28, or only at selected locations, depending on design considerations.

The shape and profile of the cooling apertures can vary from location to location on the combustor cap assembly. The shape and profile of the cooling apertures can be selectively changed at different locations to provide optimum cooling and air flow performance.

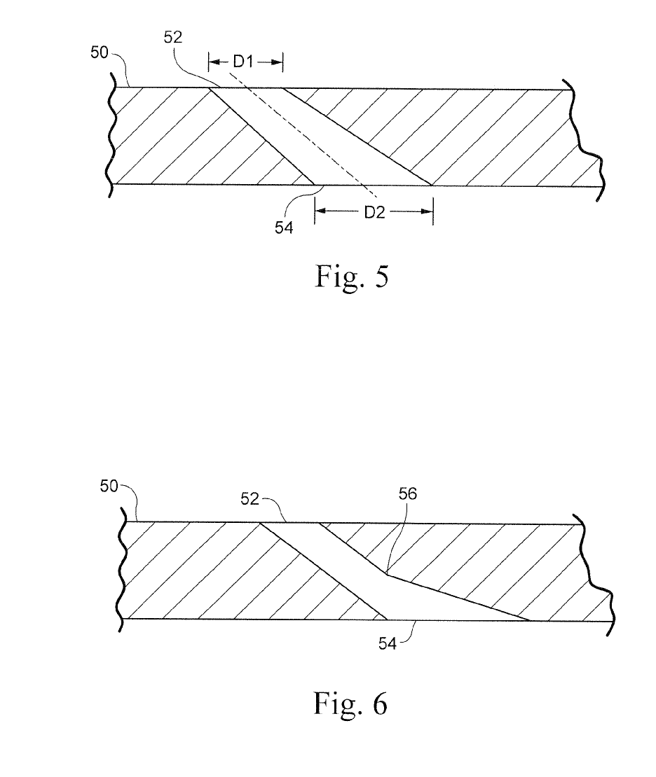

FIG. 5 illustrates one embodiment of a profile of a cooling aperture formed in a portion of a combustor cap assembly. As shown in FIG. 5, a central longitudinal axis of the cooling aperture passes through a wall of the combustor cap assembly at an angle. Because the central longitudinal axis is angled with respect to the surfaces, cooling air exiting the cooling aperture will tend to flow along the adjacent downstream portion of the surface surrounding the outlet 54 of the aperture. This prolonged contact between the cooling air and the surface of the combustor cap assembly allows for more heat to be transferred from the surface of the combustor cap assembly to the cooling air. In addition, the direction of the cooling aperture can help to guide the air flow in a particular desired direction.

In addition, the sidewalls of the cooling aperture are tapered along the length of the aperture. As a result, a diameter of the cooling aperture D1 located at the inlet 52 is smaller than a diameter D2 of the outlet 54 of the cooling aperture. Because the inner diameter of the cooling aperture becomes larger from the inlet 52 to the outlet 54, a velocity of the air traveling through the cooling aperture will slow as the air passes through the aperture. Because the air is moving slower at the outlet, the cooling air will tend to remain in contact with the surface of the combustor cap assembly adjacent the outlet 54 for a longer period of time than if the cooling air exited the cooling aperture at a higher speed. Thus, slowing of the cooling air also helps to transfer more heat from the combustor cap assembly to the cooling air.

In the embodiment illustrated in FIG. 5, the inner walls of the cooling aperture are substantially straight along the entire length of the cooling aperture. However, the walls angle away from each other from the inlet 52 to the outlet 54.

In an alternate embodiment, as shown in FIG. 6, the inner walls of the cooling aperture are substantially parallel to one another along a first length of the cooling aperture. The inner walls then begin to diverge from one another at an interim point 56 along the length of the cooling aperture. Here again, because the inner diameter of the cooling aperture widens from the interim point 56 to the outlet 54 of the cooling aperture, the air passing through the cooling aperture will slow as it nears the outlet 54. This provides all the benefits discussed above.

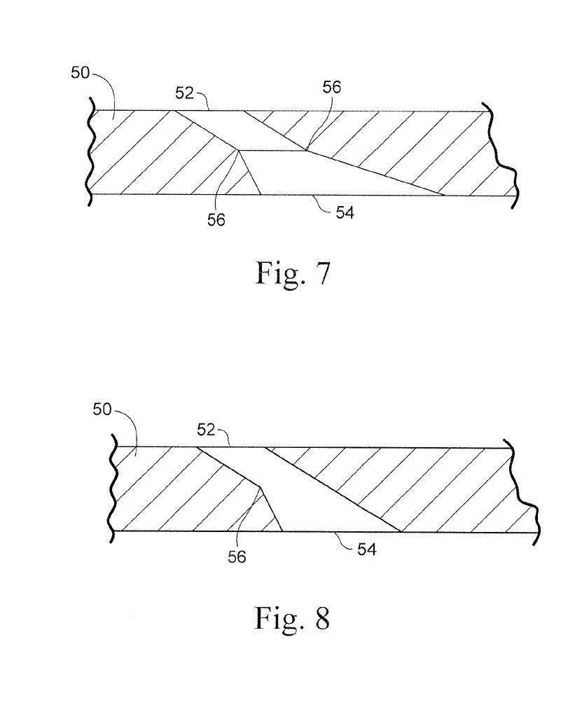

FIG. 7 shows another alternate embodiment of a cooling aperture. In this embodiment, the walls of the cooling aperture are substantially parallel to one another from the inlet 52 to the interim point 56. At the interim point, the inner walls of the cooling aperture diverge from one another to ensure that the air passing through the cooling aperture begins to slow from the interim point to the outlet 54.

Note, in the embodiment illustrated in FIG. 6, one side of the cooling aperture is substantially straight along its entire length, while the opposite sidewall diverges beginning at the interim point 56. In the embodiment shown in FIG. 7, the inner walls of the cooling aperture begin to expand outward around the entire circumference of the cooling aperture beginning at the interim point 56.

FIG. 8 illustrates another embodiment of a cooling aperture similar to the one illustrated in FIG. 6. However, in the embodiment shown in FIG. 8, the downstream side of the inner wall of the cooling aperture is straight along its entire length, while the upstream side begins to diverge at the interim point 56.

In the embodiments illustrated in FIGS. 5-8, a central longitudinal axis of the cooling aperture was angled with respect to the surface of the impingement plate. As discussed above, angling the aperture can help to improve cooling efficiency by ensuring that the air exiting the cooling aperture at the outlet stays in contact with the surface of the impingement plate surrounding the outlet for a longer period of time. The angle can also help to direct the exit airflow in a particular desired direction.

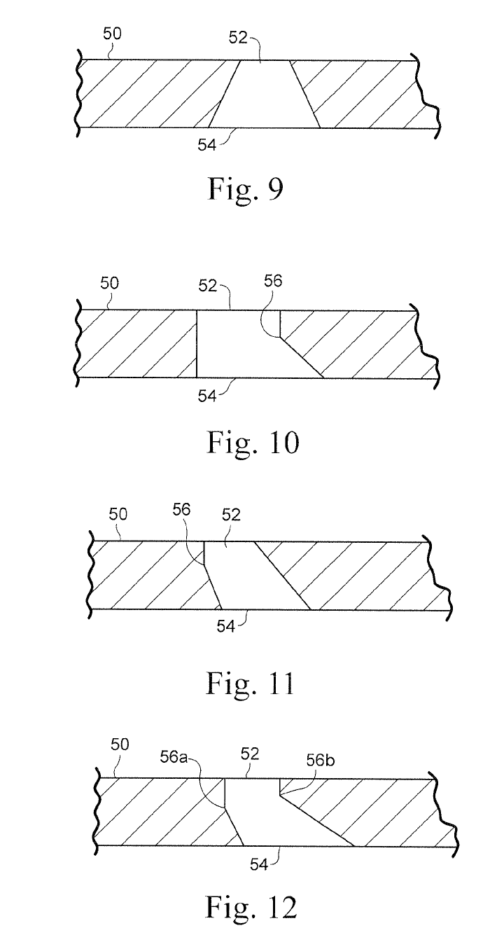

In an alternate embodiment, as shown in FIG. 9, a central longitudinal axis of a cooling aperture may be substantially perpendicular to the surrounding surfaces of the combustor cap assembly. This type of a cooling aperture may be desirable to ensure that the flow of the cooling air is directed in the desired direction as it exits the cooling aperture, in this case perpendicular to the exit surface. In the embodiment shown in FIG. 9, the inner diameter of the cooling aperture still expands from the inlet 52 to the outlet 54. As noted above, this will cause the cooling air to slow as it approaches the outlet 54.

In another alternate embodiment, as shown in FIG. 10, the inner walls of the cooling aperture extend substantially perpendicular to the surface of the combustor cap assembly surrounding the inlet 52 along a first portion of the cooling aperture. However, at an interim point 56, one sidewall of the aperture begins to expand outward. The opposite sidewall remains substantially perpendicular throughout the length of the cooling aperture.

FIG. 11 illustrates yet another embodiment wherein one interior wall of the cooling aperture is angled with respect to the surface of the combustor cap assembly surrounding the inlet 52, whereas the opposite sidewall is perpendicular to the surface. At an interim point 56, one of the sidewalls begins to become angled with respect to the surfaces of the combustor cap assembly.

FIG. 12 illustrates yet another embodiment wherein the inner walls of the cooling aperture are substantially perpendicular to the surface of the combustor cap assembly surrounding the inlet 52. However, at an interim point 56a and 56b, the inner walls of the cooling aperture become angled with respect to the outer surfaces of the impingement plate. In addition, from the interim point, the interior surfaces of the cooling aperture begin to diverge from one another.

The various embodiments illustrated in FIGS. 5-12 are intended to show that the inner profile of a cooling aperture can be configured in multiple different ways. In each of the different embodiments, however, the ultimate profile of the cooling aperture acts as a diffuser to slow the cooling air as it approaches the outlet of the cooling aperture.

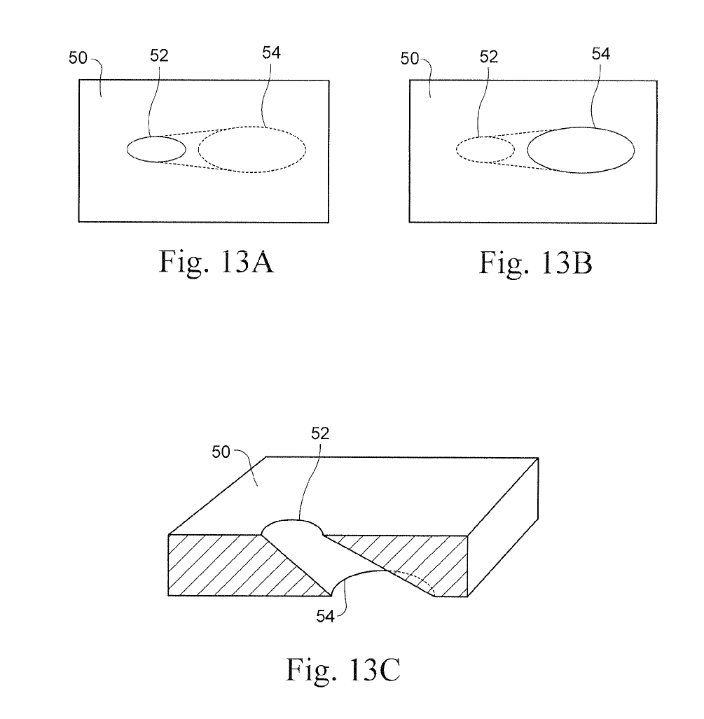

FIGS. 13a-13c illustrate yet another characteristic or feature of cooling apertures. In this embodiment, the inlet and the outlet of a cooling aperture is substantially oval-shaped. FIG. 13a presents a view of a portion of a combustor cap assembly having an inlet 52 of a cooling aperture. FIG. 13b illustrates a view of that portion of the combustor cap assembly which shows the outlet 54 of the cooling aperture. Both the inlet 52 and outlet 54 are oval-shaped. Also, the interior sidewalls of the cooling aperture are angled from the inlet to the outlet. FIG. 13c shows a sectional perspective view illustrating the oval-shaped cooling aperture.

In some embodiments, the cooling apertures can be shaped so that the inlet and outlet are circular, whereas in other embodiments the inlet and outlet can be oval shaped. In other embodiments, the inlet and outlet, and the interim portions of a cooling aperture could have alternate shapes. Further, the inlet could have a first shape, and the outlet could have a different shape. The important point is that the inner diameter of the cooling aperture expands from the inlet to the outlet. Also, as noted above, it can be advantageous to angle the central longitudinal axis of the cooling aperture so that the cooling air stays in contact with the surface of the combustor cap assembly surrounding the outlet for a longer period of time.

Further, in some embodiments, the cooling apertures could have a fixed inner diameter at some locations on a combustor cap assembly, while at other locations, the cooling apertures have a profile where the inner diameter becomes larger from the inlet to the outlet. In other words, the shaped cooling apertures discussed above might be formed only on portions of the combustor cap assembly that require maximum cooling.

While the invention has been described in connection with what is presently considered to be the most practical and preferred embodiment, it is to be understood that the invention is not to be limited to the disclosed embodiments, but on the contrary, is intended to cover various modifications and equivalent arrangements included within the spirit and scope of the appended claims.

What is claimed is:

1. A combustor cap for a turbine, comprising:
an outer sleeve; and
an impingement plate mounted in the outer sleeve, wherein a plurality of cooling apertures are formed in the impingement plate, and wherein for at least some of the cooling apertures, an area of an inlet of the cooling aperture is smaller than an area of an outlet of the cooling aperture.

2. The combustor cap of claim 1, wherein for at least some of the cooling apertures, a diameter of the aperture becomes progressively larger from the inlet to the outlet.

3. The combustor cap of claim 1, wherein for at least some of the cooling apertures, a diameter of the aperture is substantially the same from the inlet to an interim point along a length of the aperture, and wherein the diameter of the aperture becomes larger from the interim point to the outlet.

4. The combustor cap of claim 3, wherein the diameter of the aperture becomes progressively larger from the interim point to the outlet.

5. The combustor cap of claim 3, wherein for at least some of the cooling apertures, a first portion of the inner wall of the aperture is straight from the inlet to the outlet, and wherein along a second portion of the inner wall of the aperture an angle is formed at the interim point.

6. The combustor cap of claim 1, wherein for at least some of the cooling apertures, the inlet and the outlet are oval-shaped.

7. The combustor cap of claim 6, wherein for at least some of the cooling apertures, a diameter of the aperture becomes progressively larger along some portion of the total length of the cooling aperture.

8. The combustor cap of claim 1, wherein for at least some of the cooling apertures, a longitudinal axis of the aperture forms an acute angle with respect to a surface of the impingement plate.

9. The combustor cap of claim 8, wherein for at least some of the cooling apertures, a diameter of the aperture becomes progressively larger along at least a portion of the total length of the cooling aperture.

10. The combustor cap of claim 8, wherein for at least some of the cooling apertures, a diameter of the aperture is substantially the same from the inlet to an interim point along a length of the aperture, and wherein the diameter of the aperture becomes progressively larger from the interim point to the outlet.

11. A method of providing a combustor cap for a turbine, comprising:
forming a plurality of cooling apertures in an impingement plate, wherein for at least some of the cooling apertures, an area of an inlet of the cooling aperture is smaller than an area of an outlet of the cooling aperture; and
mounting the impingement plate in an outer sleeve.

12. The method of claim 11, wherein during the forming step, at least some of the cooling apertures are formed such that a diameter of the aperture becomes progressively larger from the inlet to the outlet.

13. The method of claim 11, wherein during the forming step, at least some of the cooling apertures are formed such that a diameter of the aperture is substantially the same from the inlet to an interim point along a length of the aperture, and wherein the diameter of the aperture becomes progressively larger from the interim point to the outlet.

14. The method of claim 13, wherein during the forming step, at least some of the cooling apertures are formed such that a first portion of the inner wall of the aperture is straight from the inlet to the outlet, and such that along a second portion of the inner wall of the aperture an angle is formed at the interim point.

15. The method of claim 11, wherein during the forming step, at least some of the cooling apertures are formed such that the inlet and the outlet are oval-shaped.

16. The method of claim 11, wherein during the forming step, at least some of the cooling apertures are formed such that a longitudinal axis of the aperture forms an acute angle with respect to a surface of the impingement plate.

17. The method of claim 16, wherein during the forming step, at least some of the cooling apertures are formed such that a diameter of the aperture becomes progressively larger along at least a portion of the total length of the cooling aperture.

18. The method of claim 16, wherein during the forming step, at least some of the cooling apertures are formed such that a diameter of the aperture is substantially the same from the inlet to an interim point along a length of the aperture, and such that the diameter of the aperture becomes progressively larger from the interim point to the outlet.
